(19) United States
(12) Patent Application Publication
(10) Pub. No.: US 2026/0342650 A1
(43) Pub. Date: Oct. 29, 2026

(54) SETTING DEVICE AND IN-VEHICLE EQUIPMENT

(71) Applicants: TOYOTA JIDOSHA KABUSHIKI KAISHA, Toyota-shi, Aichi-ken (JP); SUMITOMO ELECTRIC INDUSTRIES, LTD., Osaka-shi (JP); AUTONETWORKS TECHNOLOGIES, LTD., Yokkaichi-shi (JP); SUMITOMO WIRING SYSTEMS, LTD., Yokkaichi-shi (JP)

(72) Inventors: Yasuhiro YAMASAKI, Nisshin-shi (JP); Hideki GOTO, Okazaki-shi (JP); Ikuyoshi OTAKE, Toyota-shi (JP); Yusuke YAMAMOTO, Osaka-shi (JP); Ryo YAMANE, Osaka-shi (JP); Kenta OGATA, Osaka-shi (JP); Tatsuya IZUMI, Osaka-shi (JP); Hideyuki TANAKA, Osaka-shi (JP); Darmawan GO, Yokkaichi-shi (JP); Yoshitaka KIKUCHI, Yokkaichi-shi (JP); Hirofumi URAYAMA, Yokkaichi-shi (JP)

(73) Assignees: TOYOTA JIDOSHA KABUSHIKI KAISHA, Toyota-shi, Aichi-ken (JP); SUMITOMO ELECTRIC INDUSTRIES, LTD., Osaka-shi (JP); AUTONETWORKS TECHNOLOGIES, LTD., Yokkaichi-shi (JP); SUMITOMO WIRING SYSTEMS, LTD., Yokkaichi-shi (JP)

(21) Appl. No.: 19/121,983

(22) PCT Filed: Oct. 5, 2023
(86) PCT No.: PCT/JP2023/036309

§ 371 Date: Apr. 17, 2025

(30) Foreign Application Priority Data
Nov. 1, 2022 (JP) 2022-175498

(51) Int. Cl. H04L 41/082; H04L 41/069; H04L 67/12

(52) U.S. Cl. CPC H04L 41/082; H04L 41/069; H04L 67/12

(57) ABSTRACT

When a new vehicle on-board device is connected to a vehicle on-board network, a SDN controller updates communication settings of each SDN switch based on configuration information acquired from the new vehicle on-board device.

### CROSS-REFERENCE TO RELATED APPLICATIONS

This application is national stage application of International Application No. PCT/JP 2023/036309, filed on Oct. 5, 2023, which designates the United States, and which claims the benefit of priority from Japanese Patent Application No. 2022-175498, filed on Nov. 1, 2022, the entire contents of which is incorporated herein by reference.

### TECHNICAL FIELD

The present disclosure relates to a configuration device and a vehicle on-board device.

### BACKGROUND ART

Patent Literature 1 discloses a software defined networking (SDN) system that enables modification of the configuration and settings of a vehicle on-board network by controlling a communication device with software, without altering the hardware configuration. The SDN system includes SDN switches and an SDN controller that updates the communication settings of each SDN switch.

### CITATION LIST

### Patent Literature

Patent Literature 1: Japanese Laid-Open Patent Publication No. 2017-169044

### SUMMARY OF INVENTION

### Technical Problem

The SDN system as described above may be used in a vehicle on-board network. Meanwhile, in a vehicle, new vehicle on-board devices may be connected to the vehicle on-board network for purposes such as the addition of functions. When connecting a new vehicle on-board device changes the configuration of the vehicle on-board network, it is necessary to update the settings of the SDN switches in a suitable manner.

### Solution to Problem

An aspect of the present disclosure provides a configuration device. When a vehicle on-board device that executes frame-based communication is connected to a vehicle on-board network including communication devices that execute the frame-based communication, the configuration device updates communication settings of the communication devices based on configuration information acquired from the vehicle on-board device.

Another aspect of the present disclosure provides a vehicle on-board device. The vehicle on-board device is connected to a vehicle on-board network to execute frame-based communication. The vehicle on-board network includes communication devices that execute the frame-based communication. The vehicle on-board device includes a memory that stores configuration information that is related to communication settings of the communication devices.

A further aspect of the present disclosure provides a configuration device. When a vehicle on-board device that executes message-based communication is connected to a vehicle on-board network including communication devices that execute the message-based communication. The configuration device updates communication settings of the communication devices based on configuration information acquired from the vehicle on-board device.

Yet another aspect of the present disclosure provides a vehicle on-board device. The vehicle on-board device is connected to a vehicle on-board network to execute message-based communication. The vehicle on-board network includes communication devices that execute the message-based communication. The vehicle on-board device includes a memory that stores configuration information that is related to communication settings of the communication devices.

### BRIEF DESCRIPTION OF DRAWINGS

FIG. 1 is a schematic diagram illustrating the configuration of a vehicle on-board network including a configuration device and a vehicle on-board device according to an embodiment.

FIG. 2 is a diagram schematically illustrating the configuration of the vehicle on-board device.

FIG. 3 is a sequence diagram illustrating an example of the update operation for the communication settings of the vehicle on-board network.

FIG. 4 is a sequence diagram illustrating another example of the settings update operation for the communication device in the configuration device.

### DESCRIPTION OF EMBODIMENTS

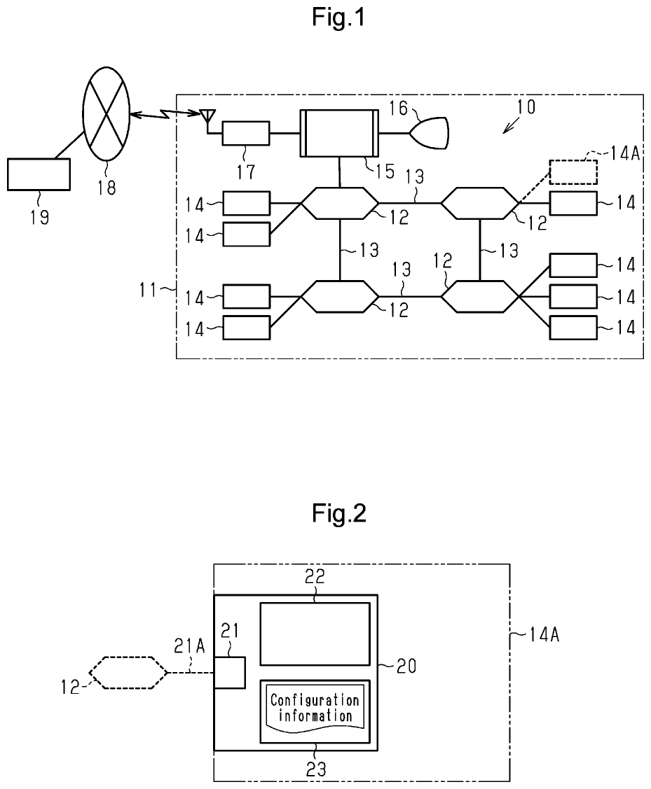

An embodiment of a configuration device and a vehicle on-board device will now be described in detail with reference to FIGS. 1 to 4.

### Configuration of Vehicle On-Board Network

First, the configuration of a vehicle on-board network 10 in which the present embodiment is employed will be described with reference to FIG. 1. As shown in FIG. 1, the vehicle on-board network 10 installed in a vehicle 11 includes SDN switches 12. Each SDN switch 12 is a communication device that performs frame forwarding. The SDN switches 12 are connected to each other via a network link 13. Each SDN switch 12 is connected to vehicle on-board devices 14. Each vehicle on-board device 14 is mounted on the vehicle 11, and transmits and receives frames via the vehicle on-board network 10. The vehicle on-board device 14 includes various electronic control units (ECUs), sensors, and a car navigation system that are mounted on the vehicle 11. The SDN switches 12 and the vehicle on-board devices 14 are communication devices that perform frame-based communication. The frame-based communication refers to performing at least one of frame forwarding, frame transmission, and frame reception.

One of the SDN switches 12 is connected to an SDN controller 15. The SDN controller 15 is a configuration device that controls the communication settings of each SDN switch 12. The communication settings define the rules for frame forwarding, including the communication paths for frames between the vehicle on-board devices 14, restrictions on communication paths for security, and adjustments to transmission order and transmission volume for quality of service (QOS). For example, the communication settings include a routing table that specifies the destination for the transfer of frames for each address.

Additionally, the SDN controller 15 is connected to a display device 16 capable of outputting images. The display device 16 is, for example, the display of a car navigation system. In the present embodiment, in addition to outputting images, a device that allows for input operations (e.g., touch operations) is employed as the display device 16. Further, the SDN controller 15 is connected to a wireless communication device 17. The wireless communication device 17 establishes data communication with an external data center 19 via a wireless communication network 18, such as a mobile communication network. The data center 19 includes a database that stores configuration information of the SDN switches 12 in various configurations of the vehicle on-board network 10. In FIG. 1, the display device 16 and the wireless communication device 17 are directly connected to the SDN controller 15. Instead, the display device 16 and the wireless communication device 17 may be connected to the SDN controller 15 via the vehicle on-board network 10.

### Connection of New Vehicle On-Board Device to Vehicle On-Board Network

There may be a case in which a new vehicle on-board device 14 is connected to the vehicle on-board network 10 to add new functions or the like to the vehicle 11. Connecting the new vehicle on-board device 14 to the vehicle on-board network 10 includes not only installing the new vehicle on-board device 14 in the vehicle 11 but also the following two cases.

One case is to activate a vehicle on-board device 14 in a deactivated state that is installed in the vehicle 11. At present, a vehicle on-board device may be preinstalled in a deactivated state in the vehicle 11 to implement a function that is currently prohibited by regulations, in anticipation of future regulatory revisions. A vehicle on-board device in a deactivated state is ignored by the vehicle on-board network 10, even if it is physically connected to the vehicle on-board network 10. When activated, such a vehicle on-board device is treated as if being newly connected to the vehicle on-board network 10. In the present embodiment, the connection of a vehicle on-board device 14 activated from a deactivated state is included in the connection of a new vehicle on-board device 14 to the vehicle on-board network 10.

Another case is to reconnect the vehicle on-board device 14 that has undergone a software update. A vehicle on-board device 14 that has already been connected to the vehicle on-board network 10 may gain new functions through a software update. When new functions are added via a software update, it may be necessary to update the communication settings of each SDN switch 12. During the software update, the vehicle on-board device 14 is temporarily disconnected from the vehicle on-board network 10. After the software update is completed, the vehicle on-board device 14 is reconnected to the vehicle on-board network 10. In the present embodiment, such reconnection after a software update is included in the connection of a new vehicle on-board device 14 to the vehicle on-board network 10. When a software update is performed, the configuration information stored in the memory 23 is also updated accordingly.

### Configuration of Network Connection Unit for Vehicle On-Board Devices

When a new vehicle on-board device 14 is connected, the communication settings of each SDN switch 12 in the vehicle on-board network 10 may be changed from the factory settings. In the present embodiment, to automate a process that updates such communication settings, the vehicle on-board device 14, which is expected to be newly connected to the vehicle on-board network 10 after the shipment of the vehicle 11, has the configuration described below. In the following description, the vehicle on-board device 14 that is newly connected to the vehicle on-board network 10 will be referred to as the new vehicle on-board device 14A.

The configuration of a network connection unit 20 of the new vehicle on-board device 14A will now be described with reference to FIG. 2. The new vehicle on-board device 14A is connected to the vehicle on-board network 10 via the network connection unit 20. The new vehicle on-board device 14A performs frame-based communication via the network connection unit 20.

The network connection unit 20 of the new vehicle on-board device 14A includes a connector 21, a CPU 22, and a memory 23. The connector 21 is connected to a communication line 21A that is used to connect an SDN switch 12 to the new vehicle on-board device 14A. The CPU 22 executes processes related to the reception and transmission of frames for the new vehicle on-board device 14A. The memory 23 stores, in advance, programs and data used for the processing by the CPU 22. Further, the memory 23 stores, in advance, the configuration information of the vehicle on-board network 10 to which the new vehicle on-board device 14A will be connected. The configuration information indicates the communication settings of each SDN switch 12 in a state in which the new vehicle on-board device 14A is connected to the vehicle on-board network 10. In the present embodiment, the memory 23 corresponds to the memory of the new vehicle on-board device 14A. Model-specific identification information (ID) is assigned to the vehicle on-board device 14. The memory 23 of the new vehicle on-board device 14A also stores, in advance, its own identification information.

An example of the new vehicle on-board device 14A is an ECU or a sensor including the network connection unit 20 shown in FIG. 2. Another example of the new vehicle on-board device 14A is a unit including one or more ECUs, one or more sensors, and an SDN switch to which the ECUs and the sensors are connected. In this case, any of the components of the unit includes the above-described network connection unit 20.

### Update to Communication Settings

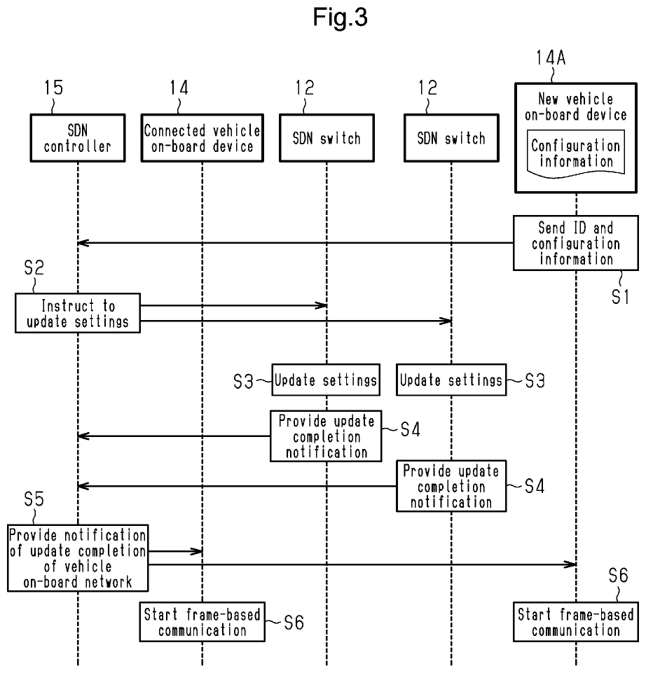

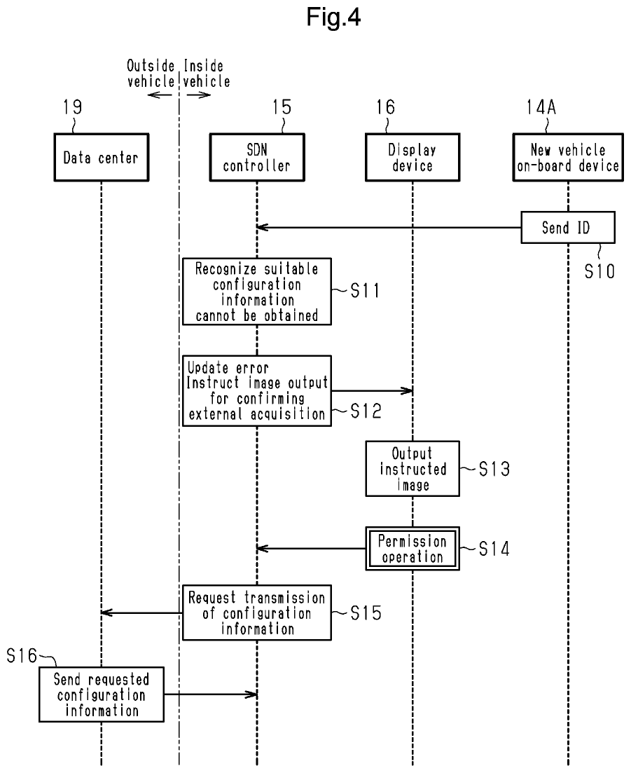

The update to the communication settings in the vehicle on-board network 10 associated with the connection of the new vehicle on-board device 14A will now be described with reference to FIGS. 3 and 4.

FIG. 3 illustrates an example of the operation of each device related to the update to the communication settings of the vehicle on-board network 10. FIG. 3 illustrates the operation performed after a new vehicle on-board device 14A is physically connected to one of the SDN switches 12 installed in the vehicle on-board network 10 and the connection between the SDN switch 12 and the new vehicle on-board device 14A is established. FIG. 3 illustrates two of the SDN switches 12 installed in the vehicle on-board network 10 and one of the vehicle on-board devices 14 already connected to the vehicle on-board network 10.

Upon being connected to the vehicle on-board network 10, the new vehicle on-board device 14A transmits the identification information (ID) and configuration information stored in its memory 23 to the SDN controller 15 (S1). The SDN controller 15 stores the identification information of each vehicle on-board device 14 already connected to the vehicle on-board network 10. Upon receiving new identification information that is not stored, the SDN controller 15 detects the connection of the new vehicle on-board device 14A to the vehicle on-board network 10. Based on the received configuration information, the SDN controller 15 instructs each SDN switch 12 installed in the vehicle on-board network 10 to update the communication settings (S2). Based on the instructions from the SDN controller 15, each SDN switch 12 updates the communication settings (S3). Upon completing the update, each SDN switch 12 notifies the SDN controller 15 of the completion (S4). Upon receiving notifications of update completion from all the SDN switches 12, the SDN controller 15 notifies each connected vehicle on-board device 14 and the new vehicle on-board device 14A that the update to the communication settings of the entire vehicle on-board network 10 is completed (S5). Upon the notification, each connected vehicle on-board device 14 initiates frame-based communication (S6). Further, the new vehicle on-board device 14A is activated in response to the notification, initiating frame-based communication (S6).

There may be cases where configuration information is not stored in the new vehicle on-board device 14A. In addition, there may be cases where the configuration information stored in the new vehicle on-board device 14A does not match the configuration of the connected vehicle on-board network 10.

FIG. 4 illustrates the operation of each device related to updating the communication settings of the vehicle on-board network 10 in such cases. FIG. 4 illustrates a case where configuration information is not stored in the new vehicle on-board device 14A.

After being connected to the vehicle on-board network 10, the new vehicle on-board device 14A in this case transmits only its own identification information to the SDN controller 15 (S10). The SDN controller 15 recognizes that it failed to obtain suitable configuration information from the new vehicle on-board device 14A, based on the fact that it received only the identification information and did not receive the configuration information (S11). When the new vehicle on-board device 14A transmits configuration information that does not match the configuration of the vehicle on-board network 10, the SDN controller 15 recognizes from the content of the received configuration information that it failed to obtain suitable configuration information.

When recognizing that it failed to obtain configuration information that does not match the vehicle on-board network 10, the SDN controller 15 instructs the display device 16 to output the image described below (S12). The image to be output as instructed provides a notification of an error in updating the communication settings of the vehicle on-board network 10. Also, this image is used to confirm whether configuration information can be obtained from outside the vehicle. The display device 16 outputs the image as instructed by the SDN controller 15 (S13). When receiving an operation permitting the acquisition of configuration information from outside the vehicle (S14), the display device 16 notifies the SDN controller 15 that such permission has been granted.

Upon receiving the notification, the SDN controller 15 requests that the external data center 19 transmit the configuration information (S15). In this step, the SDN controller 15 sends information indicating the configuration of the vehicle on-board network 10 to which it is connected, as well as the identification information of the new vehicle on-board device 14A, to the data center 19. The data center 19 sends the configuration information selected based on the received information to the SDN controller 15 (S16). Once the SDN controller 15 has acquired the suitable configuration information in this manner, the communication settings of the vehicle on-board network 10 are subsequently updated through steps S2 to S6 in FIG. 2.

### Operational Advantages of Embodiment

Upon being connected to the vehicle on-board network 10, the new vehicle on-board device 14A transmits the configuration information stored in the memory 23 to the SDN controller 15. The configuration information includes information related to not only the settings of the frame transfer path but also quality-of-service settings in frame transfer and the settings of communication path restrictions for security. Based on the received configuration information, the SDN controller 15 updates the communication settings of each SDN switch 12 installed in the vehicle on-board network 10. As a result, the settings of the frame transfer path, quality of service, and communication path restrictions of each SDN switch 12 are updated. After confirming that the update to the communication settings of all the SDN switches 12 is completed, the SDN controller 15 notifies each vehicle on-board device 14 connected to the vehicle on-board network 10 and the new vehicle on-board device 14A that the update is completed. Upon receiving this notification, each vehicle on-board device 14 and the new vehicle on-board device 14A initiate a frame-based communication.

When failing to obtain suitable configuration information from the new vehicle on-board device 14A, the SDN controller 15 displays an error on the display device 16. In this case, the SDN controller 15 obtains configuration information from the external data center 19 and updates the communication settings of each SDN switch 12.

The above-described present embodiment provides the following operational advantages.

(1) The memory 23 of a new vehicle on-board device 14A, which is a vehicle on-board device 14 that is newly connected to the vehicle on-board network 10, stores the following configuration information in advance. The configuration information indicates suitable communication settings of each SDN switch 12 that is in a state in which the new vehicle on-board device 14A is connected to the vehicle on-board network 10. When connecting the new vehicle on-board device 14A to the vehicle on-board network 10, the SDN controller 15 acquires configuration information from the new vehicle on-board device 14A, and then updates the communication settings of each SDN switch 12 based on the acquired configuration information. Thus, the communication settings of each SDN switch 12 are updated without the need for external instructions on the communication settings to be updated.

(2) When connecting to the vehicle on-board network 10, the new vehicle on-board device 14A transmits configuration information to the SDN controller 15. This allows the SDN controller 15 to update the communication settings of each SDN switch 12 upon the connection of the new vehicle on-board device 14A to the vehicle on-board network 10, even without external instructions.

(3) The configuration information acquired by the SDN controller 15 from the new vehicle on-board device 14A includes the information on quality-of-service settings for frame-based communication and the information on communication path restriction settings for security. This allows advanced communication control, such as the settings of the quality of service for frame transfer and the settings of communication path restriction for security, to be executed in response to changes in the configuration of the vehicle on-board network 10 that would occur due to the connection of the new vehicle on-board device 14A.

(4) When activating the vehicle on-board device 14 that was installed in a deactivated state and when reconnecting the vehicle on-board device 14 after a software update, the SDN controller 15 updates the communication settings of each SDN switch 12 in the aforementioned manner. Thus, the communication settings of the SDN switch 12 are updated in suitable manner in response to the activation of the vehicle on-board device 14 or the software update.

(5) When failing to obtain suitable configuration information from the new vehicle on-board device 14A, the SDN controller 15 displays an error on the display device 16, which is installed in the vehicle 11. This allows an operator performing the connection of the new vehicle on-board device 14A to perform accurate status assessment and take a suitable action.

(6) When failing to obtain suitable configuration information from the new vehicle on-board device 14A, the SDN controller 15 acquires configuration information from the external data center 19. Thus, even if the suitable configuration information is not stored in the new vehicle on-board device 14A, the communication settings of each SDN switch 12 are updated in suitable manner.

(7) Acquiring configuration information from the external data center 19 may potentially take longer than acquiring it from the new vehicle on-board device 14A. To solve this problem, the SDN controller 15 acquires configuration information from the external data center 19 only after obtaining permission from an operator. Therefore, the communication settings of each SDN switch 12 are updated during a suitable period when there is sufficient time available.

(8) Upon completing the update to the communication settings of the SDN switch 12 based on configuration information, the SDN controller 15 notifies other vehicle on-board devices 14 already connected to the vehicle on-board network 10 that the update to the communication settings is completed. This allows the other vehicle on-board devices 14 already connected to the vehicle on-board network 10 to check a period during which they are able to begin frame-based communication after the completion of the update to the communication settings.

(9) Upon completing the update to the communication settings of the SDN switch 12 based on configuration information, the SDN controller 15 notifies the new vehicle on-board device 14A that the update to the communication settings is completed. The new vehicle on-board device 14A waits for a notification of update completion before initiating frame-based communication. This allows the new vehicle on-board device 14A, which is connected to the vehicle on-board network 10, to be activated during the period when the update to the communication settings is completed. As a result, frame-based communication is initiated.

### Modifications

The present embodiment may be modified as follows. The present embodiment and the following modifications can be combined as long as they remain technically consistent with each other. The present disclosure is not limited to these examples and is intended to include all modifications described by the scope of claims and corresponding to equivalents of the scope of claims.

### Processes Executed When Suitable Configuration Information Cannot Be Acquired

Configuration information may also be acquired from the data center 19 via a vehicle diagnostic terminal, such as a diagnostic tool, that is wired to the vehicle on-board network 10. In this case, the wireless communication device 17 may be omitted.

Errors may be displayed on external display devices, such as terminals for abnormality diagnosis. The operation to confirm whether configuration information can be acquired from the data center 19 may be performed on an external terminal.

The SDN controller 15 may acquire configuration information from the data center 19 without displaying errors on the display device 16 or performing the confirmation operation on the display device 16.

When failing to obtain suitable configuration information from a new vehicle on-board device 14A, the SDN controller 15 may update the communication settings using alternative methods, such as manual input, without acquiring configuration information from the external data center 19.

### Update Completion Notification

The SDN controller 15 may notify only connected vehicle on-board devices 14 or only a new vehicle on-board device 14A that the update to the communication settings of the SDN switch 12 is completed. The SDN controller 15 may notify neither the connected vehicle on-board devices 14 nor the new vehicle on-board device 14A that the update to the communication settings is completed.

### Other Modifications

After being connected to the vehicle on-board network 10, a new vehicle on-board device 14A may transmit configuration information in response to a request from the SDN controller 15.

After being connected to the vehicle on-board network 10, a new vehicle on-board device 14A may transmit only configuration information to the SDN controller 15 without transmitting identification information.

The configuration of the vehicle on-board network 10, such as the number of SDN switches 12 and the network topology, is not limited to the example shown in FIG. 1 and may be modified.

Some or all of the SDN switches 12 installed in the vehicle on-board network 10 may be replaced with other communication devices that perform frame transfer, such as routers, and allow communication settings to be updated via software.

In the vehicle on-board network 10 of the above-described embodiment, the vehicle on-board device 14 is configured to communicate at the data link layer (L2). The vehicle on-board network 10 may be configured to conduct message-based communication between vehicle on-board devices 14 at a layer other than the data link layer. That is, the SDN controller 15 of the above-described embodiment may be a device that updates the communication settings of each communication device in a vehicle on-board network that includes multiple communication devices that perform message-based communication.

To connect a new vehicle on-board device 14A, the SDN controller 15 may update not only the communication settings of the SDN switch 12 but also the communication settings of each of the already connected vehicle on-board devices 14.

The SDN controller 15 may be configured to function as a configuration device that updates the communication settings of multiple communication devices installed in the vehicle on-board network 10. For example, any of the ECUs may also be configured to function as the SDN controller 15 in the above embodiment. That is, the configuration device, which updates the communication settings of the communication devices, may include circuitry including one or more processors that perform various processes according to computer programs (software). The configuration device may be circuitry including one or more exclusive hardware circuits, such as an application-specific integrated circuit (ASIC), to execute at least part of various processes. Alternatively, the configuration device may be circuitry including a combination thereof. The processor includes a CPU and a memory, such as a RAM and a ROM. The memory stores program codes or instructions configured to cause the CPU to execute the processes. The memory, or a computer-readable medium, includes any type of medium that is accessible by general-purpose computers and dedicated computers.

1. A configuration device, wherein
the configuration device comprises circuitry, wherein
when a vehicle on-board device that executes frame-based communication is connected to a vehicle on-board network including communication devices that execute the frame-based communication, the circuitry is configured to update communication settings of the communication devices based on configuration information acquired from the vehicle on-board device.

2. The configuration device according to claim 1, wherein
the connection of the vehicle on-board device includes a reconnection of the vehicle on-board device to the vehicle on-board network after a software update to the vehicle on-board device.

3. The configuration device according to claim 1, wherein
the configuration information includes information on quality-of-service settings for the frame-based communication and information on communication path restriction settings for security.

4. The configuration device according to claim 1, wherein
when the configuration information acquired from the vehicle on-board device is not suitable, the circuitry is configured to acquire the configuration information from an external data center.

5. The configuration device according to claim 1, wherein
when the configuration information acquired from the vehicle on-board device is not suitable, the circuitry is configured to display an error on a display device installed in a vehicle.

6. The configuration device according to claim 1, wherein
when an update to the communication settings based on the configuration information is completed, the circuitry is configured to notify the vehicle on-board device of the update completion of the communication settings.

7. The configuration device according to claim 1, wherein
when an update to the communication settings based on the configuration information is completed, the circuitry is configured to notify another vehicle on-board device connected to the vehicle on-board network of the update completion of the communication settings.

8. A vehicle on-board device, wherein
the vehicle on-board device is connected to a vehicle on-board network to execute frame-based communication, the vehicle on-board network including communication devices that execute the frame-based communication, and
the vehicle on-board device comprises a memory configured to store configuration information that is related to communication settings of the communication devices.

9. The vehicle on-board device according to claim 8, wherein
the vehicle on-board device comprises circuitry configured to transmit the configuration information upon connection to the vehicle on-board network.

10. The vehicle on-board device according to claim 8, wherein
the configuration information includes information on quality-of-service settings for the frame-based communication and information on communication path restriction settings for security.

11. The vehicle on-board device according to claim 8, wherein
the vehicle on-board network includes a configuration device that updates the communication settings of the communication device based on the configuration information stored in the memory, and
after being connected to the vehicle on-board network, the vehicle on-board device is configured to wait for a notification of update completion of the communication settings from the configuration device before initiating the frame-based communication.

12. A configuration device, wherein
the configuration device comprises circuitry, wherein
when a vehicle on-board device that executes message-based communication is connected to a vehicle on-board network including communication devices that execute the message-based communication, the circuitry is configured to update communication settings of the communication devices based on configuration information acquired from the vehicle on-board device.

13. The configuration device according to claim 12, wherein
the connection of the vehicle on-board device includes a reconnection of the vehicle on-board device to the vehicle on-board network after a software update to the vehicle on-board device.

14. The configuration device according to claim 12, wherein
the configuration information includes information on quality-of-service settings for the message-based communication and information on communication path restriction settings for security.

15. The configuration device according claim 12, wherein
when the configuration information acquired from the vehicle on-board device is not suitable, the circuitry is configured to acquire the configuration information from an external data center.

16. The configuration device according to claim 12, wherein
when the configuration information acquired from the vehicle on-board device is not suitable, the circuitry is configured to display an error on a display device installed in a vehicle.

17. The configuration device according to claim 12, wherein
when an update to the communication settings based on the configuration information is completed, the circuitry is configured to notify the vehicle on-board device of the update completion of the communication settings.

18. The configuration device according to claim 12, wherein
when an update to the communication settings based on the configuration information is completed, the circuitry is configured to notify another vehicle on-board device connected to the vehicle on-board network of the update completion of the communication settings.

19-22. (canceled)
